(19) United States
(12) Patent Application Publication
(10) Pub. No.: US 2021/0198126 A1
(43) Pub. Date: Jul. 1, 2021

(54) ELECTRODIALYSIS PROCESS FOR HIGH ION REJECTION IN THE PRESENCE OF BORON

(71) Applicant: Magna Imperio Systems Corp., Houston, TX (US)

(72) Inventors: Ethan L. DEMETER, The Woodlands, TX (US); Brian M. MCDONALD, Austin, TX (US); Rachel Guia GIRON, Houston, TX (US)

(73) Assignee: Magna Imperio Systems Corp., Houston, TX (US)

(21) Appl. No.: 17/132,235

(22) Filed: Dec. 23, 2020

Related U.S. Application Data
(60) Provisional application No. 62/954,192, filed on Dec. 27, 2019.

(51) Int. Cl. C02F 1/469; C02F 1/42

(52) U.S. Cl. CPC C02F 1/4693; C02F 2103/08; C02F 1/42

(57) ABSTRACT

Provided are water treatment systems and methods of treating water that include separating boron and concentrating lithium. For example, described are water treatment systems comprising: a first phase comprising a first plurality of electrodialysis units configured to separate boron from a feed stream, and a second phase comprising a second plurality of electrodialysis units, wherein the feed stream of at least one electrodialysis unit of the second plurality of electrodialysis units comprises an outlet brine stream of at least one electrodialysis unit of the first plurality of electrodialysis units, and wherein the second plurality of electrodialysis units are configured to produce a product brine stream achieving 90-99% lithium recovery.

### CROSS-REFERENCE TO RELATED APPLICATION

This application claims the benefit of U.S. Provisional Application No. 62/954,192, filed Dec. 27, 2019, the entire contents of which are incorporated herein by reference.

### FIELD OF THE DISCLOSURE

This disclosure relates to electrochemical processes for separating boron from a lithium-based brine stream, and achieving a high concentration lithium brine stream.

### BACKGROUND OF THE DISCLOSURE

In many ion separation technologies, ions are removed from one stream and concentrated in another. A product brine stream can be designed such that it recovers valuable ions from solution at a sufficiently high concentration, allowing the product brine stream to be used as a feedstock. For example, brine streams having a high concentration of lithium (Li) ions may be used in the production of commodities, such as Li salts for the production of Li ion batteries. However, the ion separation processes used to produce the high-concentration lithium brine stream may include dissolved species that are undesired in the concentrated brine product. One such undesired species is boron.

Various processes and methods may be employed to separate boron from lithium ions during the electrochemical process. For example, one typical solution for separating boron from a lithium brine is to use a reverse osmosis system to reject all of the boron into the concentrate stream and then to use a boron-selective ion exchange resin column to remove the boron from the concentrate. However, this process has multiple drawbacks. For instance, the reverse osmosis unit limits the final brine concentration produced (typically in the 50-60 g/L range). The solubility limit for these salts is 5-10 times this value, which means that other (thermal) processes are required to further concentrate the salt solution to the point that crystallization occurs. Another major issue with this process is the need to separate all the boron from the concentrate stream after the reverse osmosis unit. While this can be accomplished with an ion exchange column, these columns must be regenerated often as the resin is exhausted. As the amount of boron to be removed is increased, so too is the frequency that regeneration must occur.

The rejection rate of boron may be reduced using reverse osmosis to promote separation from lithium. However, the rejection rate for most reverse osmosis membranes for boric acid is between 80-95% (i.e., only 5-20% of the boron can be separated). (USBR Boron Rejection by Reverse Osmosis Membranes: National Reconnaissance and Mechanism Study. Desalination and Water Purification Research and Development Program Report No. 127).

Another process for separating boron includes the addition of chemicals or contact with extractive media. Boron may be extracted using a combination of pH adjustment and introduction of slaked lime slurry to form calcium borate hydrate, which may subsequently be precipitated from the solution. Contacting an acidified brine, pH<6, containing boron with an organic medium composed of diols can strip boron from the stream. The medium may then be regenerated with an alkaline solution. The limitation of these methods resides in the requirement for large quantities of chemical addition, which in addition to high operational costs, often requires dedicated treatment equipment in order to dispose or reuse the chemical.

### SUMMARY OF THE DISCLOSURE

Provided are electrochemical processes for separating boron from a feed stream and subsequently concentrating lithium to achieve a high-concentration lithium brine. The conventional processes described above (i.e., reverse osmosis and boron-selective ion exchange, adding chemicals, contacting with extractive media) are insufficient because they cannot separate the boron from the process water to the extent necessary and/or they require specialized equipment or maintenance. Accordingly, hybrid electrochemical and membrane-based processes provided herein can achieve a high separation of boron and a high-concentration lithium brine without specialized equipment and/or high maintenance equipment.

Electrochemical processes disclosed herein include two different phases—a boron separation phase (“first phase”) and a lithium concentration phase (“second phase”). The concentration of lithium is also increased during the boron separation phase, but the primary goal of the first phase is to separate boron. A feed stream for electrochemical processes provided herein comprises lithium ions and boron (e.g., boric acid, dihydrogen borate, and borate). Boron generally exists in aqueous solutions as boric acid (H₃BO₃) but can dissociate into ions at a pKa of 9.23. Thus, to keep boron in non-ionic form (i.e., boric acid), the pH of the feed stream can be controlled to 9.23 or lower. As the pH value is decreased, so too is the number of borate ions in solution. Once the boron is sufficiently separated from the lithium, it can be removed from the process. The lithium brine resulting from this first phase may be further treated to increase the concentration of lithium.

Controlling the gradient (i.e., the ratio of the concentration of the feed stream to the concentration of the brine stream) can help efficiently and effectively concentrate lithium ions. As the concentration gradient increases, so too does the energy required to move ions across membranes of an electrodialysis device.

During the second phase, a first lithium brine of the first phase is used as an input feed stream and a second lithium brine of the first phase is used as an input brine stream. In some embodiments, an input feed stream of an electrodialysis unit may comprise the output diluate stream of another electrodialysis unit. In some embodiments, the output brine stream of an electrodialysis unit may recycle back into the input brine stream of the same electrodialysis unit and/or may feed into another electrodialysis unit as an input feed stream or as an input brine stream. The coordination of input/output streams is highly dependent on the concentrations of each individual stream. As explained above, an optimal balance of concentrations (i.e., concentration gradient—the ratio of feed stream concentration to brine stream concentration) can increase the efficiency of the system.

Provided is a water treatment system, the water treatment system comprising: a first phase comprising a first plurality of electrodialysis units configured to separate boron from a feed stream, wherein each electrodialysis unit of the first plurality of electrodialysis units comprises an inlet feed stream, an inlet brine stream, an outlet product stream, and an outlet brine stream; and a second phase comprising a second plurality of electrodialysis units, wherein each electrodialysis unit of the second plurality of electrodialysis units comprises an inlet feed stream, an inlet brine stream, an outlet product stream, and an outlet brine stream, wherein the feed stream of at least one electrodialysis unit of the second plurality of electrodialysis units comprises an outlet brine stream of at least one electrodialysis unit of the first plurality of electrodialysis units, and wherein the second plurality of electrodialysis units are configured to produce a product brine stream achieving 90-99% lithium recovery.

In some of embodiments of the water treatment system, the product brine stream achieves at least 95% lithium recovery.

In some of embodiments of the water treatment system, the product brine stream achieves at least 97% lithium recovery.

In some of embodiments of the water treatment system, the first phase comprises a first electrodialysis unit, a second electrodialysis unit, and a third electrodialysis unit.

In some of embodiments of the water treatment system, the inlet feed stream of the first electrodialysis unit of the first phase comprises the feed stream.

In some of embodiments of the water treatment system, the inlet feed stream of the second electrodialysis unit of the first phase comprises the outlet product stream of the first electrodialysis system of the first phase.

In some of embodiments of the water treatment system, the inlet feed stream of the third electrodialysis system of the first phase comprises the outlet product stream of the second electrodialysis unit of the first phase.

In some of embodiments of the water treatment system, the outlet product stream of the third electrodialysis unit of the first phase recovers greater than 95% of the boron ions of the feed stream.

In some of embodiments of the water treatment system, at least one of the inlet feed stream of the first electrodialysis unit of the first phase, the inlet feed stream of the second electrodialysis unit of the first phase, or the inlet feed stream of the third electrodialysis unit of the first phase are controlled to a pH of 7 or lower.

In some of embodiments of the water treatment system, the inlet brine stream of the first electrodialysis unit of the first phase comprises the outlet brine stream of the first electrodialysis unit of the first phase.

In some of embodiments of the water treatment system, the inlet brine stream of the second electrodialysis unit of the first phase comprises the outlet brine stream of the second electrodialysis unit of the first phase.

In some of embodiments of the water treatment system, the inlet brine stream of the third electrodialysis unit of the first phase comprises the outlet brine stream of the third electrodialysis system of the first phase.

In some of embodiments of the water treatment system, the second phase comprises a first electrodialysis unit, a second electrodialysis unit, and a third electrodialysis unit.

In some of embodiments of the water treatment system, the inlet feed stream of the first electrodialysis system of the second phase comprises at least one of the outlet brine stream of the second electrodialysis unit of the first phase or the outlet brine stream of the third electrodialysis system of the first phase.

In some of embodiments of the water treatment system, the inlet brine stream of the first electrodialysis unit of the second phase comprises the outlet brine stream of the first electrodialysis unit of the first phase.

In some of embodiments of the water treatment system, the inlet brine stream of the first electrodialysis unit of the second phase comprises the outlet brine stream of the first electrodialysis unit of the second phase.

In some of embodiments of the water treatment system, the inlet feed stream of the second electrodialysis unit of the second phase comprises the outlet product stream of the first electrodialysis unit of the second phase.

In some of embodiments of the water treatment system, the inlet brine stream of the second electrodialysis unit of the second phase comprises the outlet brine stream of the second electrodialysis unit of the second phase.

In some of embodiments of the water treatment system, the inlet feed stream of the third electrodialysis unit of the first phase comprises the outlet product stream of the second electrodialysis unit of the second phase.

In some of embodiments of the water treatment system, the inlet feed stream of a third electrodialysis unit of the second phase comprises the outlet brine stream of the second electrodialysis unit of the second phase.

In some of embodiments of the water treatment system, the inlet brine stream of the third electrodialysis unit of the second phase comprises the outlet brine stream of the first electrodialysis unit of the second phase.

In some of embodiments of the water treatment system, the inlet feed stream of the second electrodialysis unit of the first phase comprises the outlet product stream of the third electrodialysis unit of the second phase.

In some of embodiments of the water treatment system, the inlet brine stream of the third electrodialysis unit of the second phase comprises the outlet brine stream of the third electrodialysis unit of the second phase.

In some of embodiments of the water treatment system, the outlet brine stream of the third electrodialysis unit of the second phase comprises the product brine stream.

In some of embodiments of the water treatment system, the inlet feed stream of the first electrodialysis unit of the second phase comprises the outlet product stream of the second electrodialysis unit of the second phase.

In some of embodiments of the water treatment system, the inlet feed stream of the second electrodialysis unit of the second phase comprises the outlet product stream of the third electrodialysis unit of the second phase.

In some of embodiments of the water treatment system, the inlet feed stream of the first electrodialysis system of the second phase comprises at least one of the outlet brine stream of the first electrodialysis system of the first phase, the outlet brine stream of the second electrodialysis system of the first phase, or the outlet brine stream of the third electrodialysis system of the first phase.

In some of embodiments of the water treatment system, the inlet brine stream of the first electrodialysis system of the second phase comprises at least one of the outlet brine stream of the first electrodialysis system of the first phase, the outlet brine stream of the second electrodialysis system of the first phase, or the outlet brine stream of the third electrodialysis system of the first phase.

In some of embodiments of the water treatment system, the inlet brine stream of the first electrodialysis unit of the second phase comprises the outlet brine stream of the first electrodialysis system of the second phase.

In some of embodiments of the water treatment system, the inlet brine stream of the second electrodialysis unit of the second phase comprises the outlet brine stream of the second electrodialysis system of the second phase.

In some of embodiments of the water treatment system, the inlet brine stream of the third electrodialysis unit of the second phase comprises the outlet brine stream of the third electrodialysis system of the second phase.

In some of embodiments of the water treatment system, the inlet feed stream of the second electrodialysis unit of the second phase comprises the outlet brine stream of the first electrodialysis unit of the second phase.

In some of embodiments of the water treatment system, the inlet feed stream of the third electrodialysis unit of the second phase comprises the outlet brine stream of the second electrodialysis unit of the second phase.

In some embodiments, a method of separating boron and concentrating lithium is provided, the method comprising: passing water through a first phase comprising a first plurality of electrodialysis units configured to separate boron from a feed stream, wherein each electrodialysis unit of the first plurality of electrodialysis units comprises an inlet feed stream, an inlet brine stream, an outlet product stream, and an outlet brine stream; and passing water through a second phase comprising a second plurality of electrodialysis units, wherein each electrodialysis unit of the second plurality of electrodialysis units comprises an inlet feed stream, an inlet brine stream, an outlet product stream, and an outlet brine stream, wherein the feed stream of at least one electrodialysis unit of the second plurality of electrodialysis units comprises an outlet brine stream of at least one electrodialysis unit of the first plurality of electrodialysis units, and wherein the second plurality of electrodialysis units are configured to produce a product brine stream achieving 90-99% lithium recovery.

In some embodiments of the method, the product brine stream achieves at least 95% lithium recovery.

In some embodiments of the method, the product brine stream achieves at least 97% lithium recovery.

In some embodiments of the method, passing water through a first phase comprises passing water through a first electrodialysis unit, a second electrodialysis unit, and a third electrodialysis unit.

In some embodiments of the method, the method comprises routing an inlet feed stream of the first electrodialysis device of the first phase, wherein the inlet feed stream of the first electrodialysis unit of the first phase comprises the feed stream.

In some embodiments of the method, the method comprises routing an inlet feed stream of the second electrodialysis device of the first phase, wherein the inlet feed stream of the second electrodialysis unit of the first phase comprises the outlet product stream of the first electrodialysis system of the first phase.

In some embodiments of the method, the method comprises routing an inlet feed stream of the third electrodialysis device of the first phase, wherein the inlet feed stream of the third electrodialysis system of the first phase comprises the outlet product stream of the second electrodialysis unit of the first phase.

In some embodiments of the method, the outlet product stream of the third electrodialysis unit of the first phase recovers greater than 95% of the boron ions of the feed stream.

In some embodiments of the method, the method comprises controlling at least one of the inlet feed stream of the first electrodialysis unit of the first phase, the inlet feed stream of the second electrodialysis unit of the first phase, or the inlet feed stream of the third electrodialysis unit of the first phase to a pH of 7 or lower.

In some embodiments of the method, the method comprises routing an inlet brine stream of the first electrodialysis unit of the first phase, wherein the inlet brine stream of the first electrodialysis unit of the first phase comprises the outlet brine stream of the first electrodialysis unit of the first phase.

In some embodiments of the method, the method comprises routing an inlet brine stream of the second electrodialysis unit of the first phase, wherein the inlet brine stream of the second electrodialysis unit of the first phase comprises the outlet brine stream of the second electrodialysis unit of the first phase.

In some embodiments of the method, the method comprises routing an inlet brine stream of the third electrodialysis device of the first phase, wherein the inlet brine stream of the third electrodialysis unit of the first phase comprises the outlet brine stream of the third electrodialysis system of the first phase.

In some embodiments of the method, the method comprises passing water through a second phase comprises passing waster through a first electrodialysis unit, a second electrodialysis unit, and a third electrodialysis unit.

In some embodiments of the method, the inlet feed stream of the first electrodialysis system of the second phase comprises at least one of the outlet brine stream of the second electrodialysis unit of the first phase or the outlet brine stream of the third electrodialysis system of the first phase.

In some embodiments of the method, the method comprises routing an inlet brine stream of the first electrodialysis unit of the second phase, wherein the inlet brine stream of the first electrodialysis unit of the second phase comprises the outlet brine stream of the first electrodialysis unit of the first phase.

In some embodiments of the method, the method comprises routing an inlet brine stream of the first electrodialysis system of the second phase, wherein the inlet brine stream of the first electrodialysis unit of the second phase comprises the outlet brine stream of the first electrodialysis unit of the second phase.

In some embodiments of the method, the method comprises routing an inlet feed stream of the second electrodialysis unit of the second phase, wherein the inlet feed stream of the second electrodialysis unit of the second phase comprises the outlet product stream of the first electrodialysis unit of the second phase.

In some embodiments of the method, the method comprises routing an inlet brine stream of the second electrodialysis unit of the second phase, wherein the inlet brine stream of the second electrodialysis unit of the second phase comprises the outlet brine stream of the second electrodialysis unit of the second phase.

In some embodiments of the method, the method comprises routing an inlet feed stream of the third electrodialysis unit of the first phase, wherein the inlet feed stream of the third electrodialysis unit of the first phase comprises the outlet product stream of the second electrodialysis unit of the second phase.

In some embodiments of the method, the method comprises routing an inlet feed stream of the third electrodialysis unit of the second phase, wherein the inlet feed stream of the third electrodialysis unit of the second phase comprises the outlet brine stream of the second electrodialysis unit of the second phase.

In some embodiments of the method, the method comprises routing an inlet brine stream of the third electrodialysis unit of the second phase, wherein the inlet brine stream of the third electrodialysis unit of the second phase comprises the outlet brine stream of the first electrodialysis unit of the second phase.

In some embodiments of the method, the method comprises routing an inlet feed stream of the second electrodialysis unit of the first phase, wherein the inlet feed stream of the second electrodialysis unit of the first phase comprises the outlet product stream of the third electrodialysis unit of the second phase.

In some embodiments of the method, the method comprises routing an inlet brine stream of the third electrodialysis unit of the second phase, wherein the inlet brine stream of the third electrodialysis unit of the second phase comprises the outlet brine stream of the third electrodialysis unit of the second phase.

In some embodiments of the method, the method comprises routing an outlet brine stream of the third electrodialysis unit of the second phase, wherein the outlet brine stream of the third electrodialysis unit of the second phase comprises the product brine stream.

In some embodiments of the method, the method comprises routing an inlet feed steam of the first electrodialysis unit of the second phase, wherein the inlet feed stream of the first electrodialysis unit of the second phase comprises the outlet product stream of the second electrodialysis unit of the second phase.

In some embodiments of the method, the method comprises routing an inlet feed stream of the second electrodialysis unit of the second phase, wherein the inlet feed stream of the second electrodialysis unit of the second phase comprises the outlet product stream of the third electrodialysis unit of the second phase.

In some embodiments of the method, the method comprises routing an inlet feed stream of the first electrodialysis unit of the second phase, wherein the inlet feed stream of the first electrodialysis system of the second phase comprises at least one of the outlet brine stream of the first electrodialysis system of the first phase, the outlet brine stream of the second electrodialysis system of the first phase, or the outlet brine stream of the third electrodialysis system of the first phase.

In some embodiments of the method, the method comprises routing an inlet brine stream of the first electrodialysis unit of the second phase, wherein the inlet brine stream of the first electrodialysis system of the second phase comprises at least one of the outlet brine stream of the first electrodialysis system of the first phase, the outlet brine stream of the second electrodialysis system of the first phase, or the outlet brine stream of the third electrodialysis system of the first phase.

In some embodiments of the method, the method comprises routing an inlet brine stream of the first electrodialysis unit of the second phase, wherein the inlet brine stream of the first electrodialysis unit of the second phase comprises the outlet brine stream of the first electrodialysis system of the second phase.

In some embodiments of the method, the method comprises routing an inlet brine stream of the second electrodialysis unit of the second phase, wherein the inlet brine stream of the second electrodialysis unit of the second phase comprises the outlet brine stream of the second electrodialysis system of the second phase.

In some embodiments of the method, the method comprises routing an inlet brine stream of the third electrodialysis unit of the second phase, wherein the inlet brine stream of the third electrodialysis unit of the second phase comprises the outlet brine stream of the third electrodialysis system of the second phase.

In some embodiments of the method, the method comprises routing an inlet feed stream of the second electrodialysis unit of the second phase, wherein the inlet feed stream of the second electrodialysis unit of the second phase comprises the outlet brine stream of the first electrodialysis unit of the second phase.

In some embodiments of the method, the method comprises routing an inlet feed stream of the third electrodialysis unit of the second phase, wherein the inlet feed stream of the third electrodialysis unit of the second phase comprises the outlet brine stream of the second electrodialysis unit of the second phase.

### BRIEF DESCRIPTION OF THE FIGURES

The invention will now be described, by way of example only, with reference to the accompanying drawings, in which:

FIG. 1 shows a schematic representation of an electrochemical ion separation device, according to some embodiments;

FIG. 2 shows a schematic representation of an electrodialysis device treating a feed stream comprising lithium and boron, according to some embodiments;

FIG. 3 shows a schematic representation of an electrodialysis device treating a feed stream comprising lithium and boron, according to some embodiments;

FIG. 4 shows a process flow diagram showing a process for concentrating lithium while separating it from a feed stream comprising boron, according to some embodiments; and

FIG. 5 shows a process flow diagram for separating lithium from boron in a feed stream and concentrating the lithium to achieve a high-concentration lithium brine, according to some embodiments.

### DETAILED DESCRIPTION OF THE DISCLOSURE

Provided are electrochemical systems for separating boron and concentrating lithium from a feed stream. In particular, a first phase of the disclosed electrochemical systems separates boron from the other dissolved species in the feed water. A second phase further concentrates the dissolved lithium, generating a high-concentration lithium brine. In some embodiments, no additional chemicals are required to achieve the high-concentration lithium brine. This high-concentration lithium brine can be used as feedstock in the production of commodities such as Li salts for the production of Li ion batteries.

In aqueous solution, boron typically exists as boric acid (H₃BO₃). However, boric acid readily dissociates into ions according to the equation below, having a pKa of 9.23:

H₃BO₃↔H⁺+BO₂⁻+H₂O;pKₐ=9.23

However, if the pH of the aqueous solution is controlled to a level below 9.23, boric acid less readily dissociates. As the pH of aqueous solution decreases, so too does the number of dissociated ions. Accordingly, the feed stream in phase one of the disclosed electrochemical processes may be controlled to a pH lower than 9 to limit the rate of boric acid dissociation.

Once the boron is sufficiently separated from the feed stream, a concentrated lithium brine is generated in phase two. To achieve an efficient lithium-concentrating electrochemical system, the gradient across the feed and brine streams (i.e., the ratio of diluate concentration to concentrate concentration) may be carefully controlled.

### Operation of an Electrodialysis Device

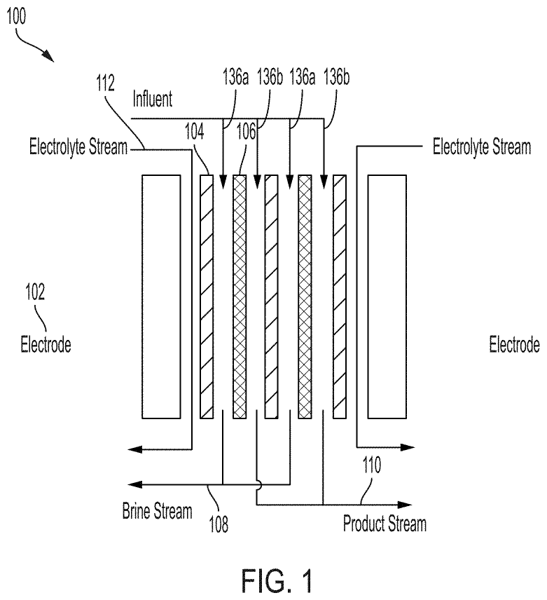

Provided below is a discussion of the basic operation of an individual electrodialysis device according to some embodiments and with respect to FIG. 1. High-recovery electrodialysis systems and methods for desalinating water provided herein may include two or more individual electrodialysis devices.

An individual electrodialysis device (i.e., an ion-exchange device) can include at least one pair of electrodes and at least one pair of ion-exchange membranes placed there between. The at least one pair of ion-exchange membranes can include a cation-exchange membrane (“CEM”) and an anion-exchange membrane (“AEM”). In addition, at least one of the ion-exchange membranes (i.e., CEMs and/or AEMs) has a spacer on the surface of the ion-exchange membrane facing the other ion-exchange membrane in an electrodialysis device. In some embodiments, both the CEMs and the AEMs have a spacer on at least one surface facing the other ion-exchange membrane. The spacer can include a spacer border and a spacer mesh.

FIG. 1 shows a schematic side view of electrodialysis device 100 according to some embodiments disclosed herein. Ion-exchange system 100 can include CEMs 104 and AEMs 106 sandwiched between two electrodes 102. In some embodiments, one or more CEM 104 and one or more AEM 106 may alternate throughout a length of the electrodialysis device 100.

An electrode 102 is shown on opposing ends of electrodialysis device 100. One electrode 102 can be a cathode and another electrode 102 can be an anode. In some embodiments, one or more electrodes 102 can encompass one or more fluid channels for electrolyte stream 112. Electrolyte stream 112 may comprise raw influent, a separately-managed electrolyte fluid, a sodium chloride solution, sodium sulfate, iron chloride, or another suitable conductive fluid. For example, a fluid channel for electrolyte stream 112 of electrode 102 can be located between one or more CEM 104 and an electrode 102, or between one or more AEM 106 and an electrode 102. Electrodialysis device 100 may also include one or more fluid channels for influent streams 136a and 136b. Influent streams 136a and 136b may be located between a CEM 104 and an AEM 106. Influent streams 136a and 136b can comprise water. In some embodiments, water of influent streams 136a and 136b may be purified by flowing through one or more intermembrane chambers located between two or more alternating CEM 104 and AEM 106. In particular, influent stream 136a may flow through electrodialysis device 100 and exit electrodialysis device 100 as brine stream 108. Influent stream 136b may flow through electrodialysis device 100 and exit electrodialysis device 100 as product stream 110. Thus, influent stream 136a is a brine inlet stream for electrodialysis device 100, and influent stream 136b is a product inlet stream for electrodialysis device 100 of FIG. 1. Of course, the ionic composition of the streams within each channel may change when an electric current is applied to the device, allowing ions to migrate from one channel to an adjacent channel.

AEM 106 can allow passage of negatively charged ions and can substantially block the passage of positively charged ions. Conversely, CEM 104 can allow the passage of positively charged ions and can substantially block the passage of negatively charged ions.

Electrolyte stream 112 may be in direct contact with one or more electrodes 102. In some embodiments, electrolyte stream 112 may comprise the same fluid as the fluid of influent streams 136a and 136b. In some embodiments, electrolyte stream 112 may comprise a fluid different from the fluid of influent streams 136a and 136b. For example, electrolyte stream 112 can be any one or more of a variety of conductive fluids including, but not limited to, raw influent, a separately managed electrolyte fluid, NaCl solution, sodium sulfate solution, or iron chloride solution.

In some embodiments, electrodialysis device 100 can include one or more spacers on at least one surface of a CEM 104 or an AEM 106. In some embodiments, one or more spacer may be located on two opposing surfaces of a CEM 104 and/or an AEM 106. Further, electrodialysis device 100 may include one or more spacers between any two adjacent ion-exchange membranes (i.e., between an AEM 106 and a CEM 104). The region formed between any two adjacent ion-exchange membranes by one or more spacers forms an intermembrane chamber.

When an electric charge is applied to one or more electrodes 102 of electrodialysis device 100, the ions of influent streams 136a and 136b flowing through an intermembrane chamber between any two ion-exchange membranes (i.e., one or more CEM 104 and one or more AEM 106) can migrate towards the electrode of opposite charge. Specifically, ion-exchange membranes can comprise ionically conductive pores having either a positive or a negative charge. These pores can be permselective, meaning that they selectively permeate ions of an opposite charge. Thus, the alternating arrangement of the ion-exchange membranes can generate alternating intermembrane chambers comprising decreasing ionic concentration and comprising increasing ionic concentration as the ions migrate towards the oppositely-charged electrode 102.

An intermembrane chamber can be formed from a spacer border and a spacer mesh and can create a path for fluids to flow. The number of intermembrane chambers may be increased by introducing additional alternating pairs of ion-exchange membranes. Introducing additional alternating pairs of CEMs 104 and AEMs 106 (and the intermembrane chambers formed between each pair of ion-exchange membranes) can also increase the capacity of electrodialysis device 100. In addition, the functioning ability of an individual ion-exchange cell (i.e., a single CEM 104 paired with a single AEM 106 to form a single intermembrane chamber) can be greatly augmented by configuring ion-exchange cells into ion-exchange stacks (i.e., a series of multiple ion-exchange cells.)

As described above, ions of influent streams 136a and 136b flowing through an intermembrane chamber can migrate towards electrode 102 of opposite charge when an electric current is applied to electrodialysis device 100. The ion-exchange membranes have a fixed charge (CEMs have a negative charge, AEMs have a positive charge). Thus, as a counter-ion approaches an ion-exchange membrane (e.g., as a cation approaches a CEM), the counter-ion is freely exchanged through the membrane. The removal of this counter-ion from the stream makes the stream a product stream. On the other hand, when a co-ion approaches the ion-exchange membrane (e.g., as an anion approaches a CEM), it is electrostatically repelled from the CEM. This separation mechanism can separate influent streams 136a and 136b into two different streams of opposite ionic charge. For example, when used for desalination, influent stream 136a may flow to brine stream 108, and influent stream 136b may flow to product stream 110. Brine stream 108 is generally a waste stream. In some embodiments, product stream 110 may have a lower ionic concentration than brine stream 108.

In some embodiments, product stream 110 may have a predetermined treatment level. For example, ion-exchange system 100 may be configured to remove several types of ions (e.g., monovalent ions, divalent ions, etc.) or it may be configured to remove a specific type of ion (e.g., arsenic, fluoride, perchlorate, lithium, gold, silver, etc.). Further, ion-exchange system 100 can be held together using a compression system that comprises using two compression plates on opposite ends of the device. In some embodiments, a single pair of compression plates may be used (i.e., one on either end of the outside of the stack) to achieve a working, reliable seal.

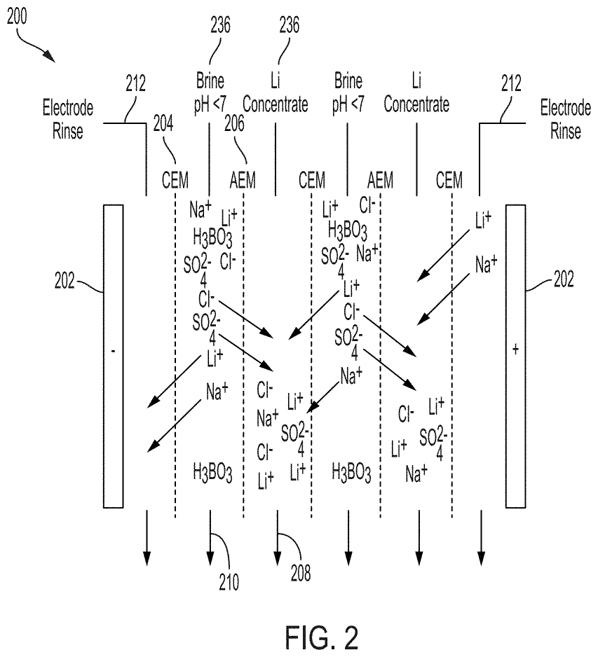

FIG. 2 shows the basic operation of an electrodialysis device 200. Specifically, FIG. 2 shows the separation of boron in an electrodialysis device when the input influent stream is controlled to a pH below 7. Electrodialysis device 200 can include a pair of electrodes 202, an electrolyte stream 212, a plurality of CEMs 204, a plurality of AEMs 206, influent stream 236, output product stream 210, and output brine stream 208.

As explained with reference to FIG. 1, above, when a potential is applied across the electrodes 202 of the electrodialysis device 200, ions within the streams begin to migrate across the ion exchange membranes. However, when the pH of influent stream 236 is controlled to a level below 7, boron has a tendency to remain in boric acid form. At a higher pH (i.e., 9.23 and higher), boric acid has a tendency to dissociate into ions according to the equation provided above. Because the pKa of the equation is 9.23, boric acid tends to resist dissociation more as the pH decreases. Acids such as sulfuric acid, hydrochloric acid, or citric acid may be used to control the pH.

As shown in the Figure, influent stream 236 comprises dissolved species such as sodium ions, lithium ions, boric acid, sulfate, and chlorine ions. So long as the pH of influent stream 236 remains below 9, the boron should remain in boric acid form. However, the lower the pH, generally the better. Because boric acid is non-ionic, it will not migrate across a membrane, and will instead stay within the channel between the CEM 204 and the AEM 206 that it is routed to. Thus, the boric acid of influent stream 236 will pass through electrodialysis device 200 without migration across any membranes, and will exit electrodialysis device with output product stream 210. Conversely, the dissolved ions in influent stream 236—sodium ions, lithium ions, sulfate, and chlorine ions—will migrate across at least one membrane and towards the electrode of opposite charge. Thus, the sulfate and chlorine ions, both of which are negatively-charged, will migrate across the adjacent anion-exchange membrane 206 and towards electrode 202 having a positive charge. Similarly, the lithium and sodium ions, both of which are positively-charged, will migrate across the adjacent cation-exchange membrane 204 and towards electrode 202 of negative charge. Only boric acid (and any other non-ionic species) will remain in the influent stream 236 and exit electrodialysis device 200 with product stream 210. The ionic species that have migrated across an ion-exchange membrane will exit electrodialysis device in output brine stream 208.

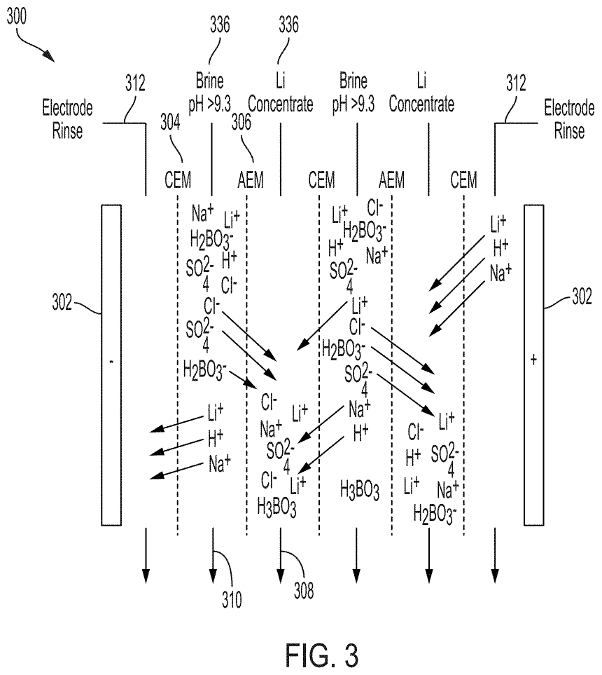

FIG. 3 shows electrodialysis device 300 that comprises influent stream 336 that is not controlled to a pH of less than 9. Instead, the pH of influent stream 336 is 9.3 or greater. Electrodialysis device 300 comprises a pair of electrodes 302, an electrolyte stream 312, a plurality of AEMs 306, a plurality of CEMs 304, influent stream 336, outlet product stream 310, and outlet brine stream 308.

Because the pH of influent stream 336 is 9.3 or greater, the boric acid dissociates into ions according to the equation provided above. Thus, boron ions migrate across an adjacent anion-exchange membrane 306 towards electrode 302 of opposite charge. Because the boron ions migrate into an adjacent channel, the boron ions exit electrodialysis device 300 with outlet brine stream 308. This fails to separate boron from lithium, since lithium also exits electrodialysis device 300 in outlet brine stream 308.

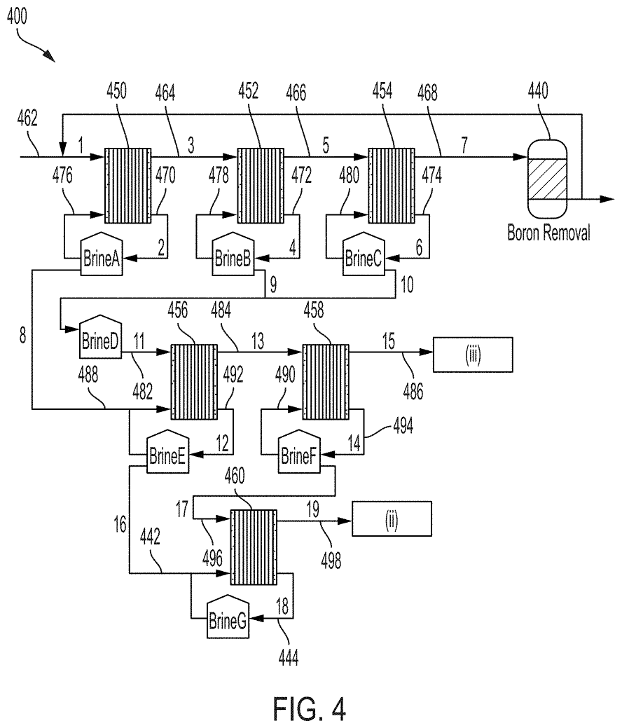

FIG. 4 shows a process diagram for an electrochemical process 400 that separates boron and concentrates lithium, according to some embodiments. As shown, the first phase of electrochemical process 400 includes three electrodialysis units (450, 452, and 454). The second phase of electrochemical process 400 also includes three electrodialysis units (456, 458, and 460). However, the first phase and the second phase each may comprise any number of electrodialysis units such as 2, 3, 4, 5, 6, 7, 8, 9, or 10.

The gradient (i.e., the ratio of the concentration of the feed stream to the concentration of the brine stream) of each electrodialysis unit may be controlled for a more efficient process. In the first phase, the gradient may be less than 100. In some embodiments, the gradient may be less than 20. Maintaining a relatively low gradient can reduce the polarization on the membrane surface, leading to lower power consumption. A relatively low gradient can also reduce the osmotic pressure across the membrane, which can otherwise lead to significant water transfer into the brine stream.

The first phase of electrochemical process 400 includes feed stream 462 that is routed into the first electrodialysis unit 450. In some embodiments, feed stream may comprise lithium, boron, and other dissolved species. In some embodiments, the concentration of lithium in feed stream 462 may be 100-5,000 milligrams per Liter (mg/L). In some embodiments, the concentration of lithium in feed stream 462 may be less than 5,000 mg/L, less than 4,000 mg/L, less than 3,000 mg/L, less than 2,000 mg/L, less than 1,000 mg/L, or less than 500 mg/L. In some embodiments, the concentration of lithium in feed stream 462 may be greater than 100 mg/L, greater than 500 mg/L, greater than 1,000 mg/L, greater than 2,000 mg/L, greater than 3,000 mg/L, or greater than 4,000 mg/L. In some embodiments, the concentration of boron in feed stream 462 may be 50-1,000 mg/L. In some embodiments, the concentration of boron in feed stream 462 may be less than 1,000 mg/L, less than 500 mg/L, or less than 100 mg/L. In some embodiments, the concentration of boron in feed stream 462 may be greater than 50 mg/L, greater than 100 mg/L, or greater than 500 mg/L.

In some embodiments, the pH of the feed streams and/or product streams of the first phase may be controlled. For example, the pH of streams 462, 464, 466, and/or 468 may be controlled. In some embodiments, these streams may be controlled to a pH below 9, to minimize the amount of boric acid that dissociates into ions. In some embodiments, these streams may be controlled to a pH of 5-9. In some embodiments, the pH may be less than 9, less than 8, less than 7, or less than 6. In some embodiments, the pH may be more than 5, more than 6, more than 7, or more than 8. In some embodiments, the lower the pH is (and the further away from a pH of 9), the lower the dissociation rate of boric acid. To achieve an outlet product stream of the first phase that comprises at least 85% boron, the pH of the feed and/or product streams should be controlled to a level below 9.

Electrochemical process 400 also includes streams 464 and 466 that are each the outlet product streams of one electrodialysis unit and the inlet product stream of a second electrodialysis unit. Specifically, stream 464 is the outlet product stream of electrodialysis unit 450 and the inlet feed stream of electrodialysis unit 452. Stream 466 is the outlet product stream of electrodialysis unit 452 and the inlet feed stream of electrodialysis unit 454. Stream 468 is the outlet product stream of electrodialysis unit 454 and comprises 85-99% of the boron initially present in feed stream 462. In some embodiments, stream 468 comprises at least 85%, at least 90%, or at least 95% of the boron initially present in feed stream 462. In some embodiments, stream 468 comprises less than 99%, less than 95%, or less than 90% of the boron initially present in feed stream 462. Boron removal unit 440 processes the boron from stream 468. For example, boron removal unit 440 may use adsorptive media or reverse osmosis. In some embodiments, stream 468 may comprise 0.1-15% of the lithium originally present in feed stream 462. In some embodiments, stream 468 may comprise less than 15%, less than 10%, less than 5%, or less than 1% of the lithium originally present in feed stream 462. In some embodiments, stream 468 may comprise more than 0.1%, more than 1%, more than 5%, or more than 10% of the lithium originally present in feed stream 462.

Each electrodialysis unit of the first phase includes an inlet brine stream and an outlet brine stream. Specifically, stream 476 is the inlet brine stream of electrodialysis unit 450, and stream 470 is the brine outlet stream for electrodialysis unit 450. Stream 478 is the inlet brine stream of electrodialysis unit 452, and stream 472 is the outlet brine stream of electrodialysis unit 452. Finally, stream 480 is the inlet brine stream for electrodialysis unit 454 and stream 474 is the outlet brine stream for electrodialysis unit 454. In some embodiments, the inlet brine stream for a particular electrodialysis unit comprises the outlet brine stream for the same electrodialysis unit. For example, inlet stream 476 comprises stream 470, inlet stream 478 comprises stream 472, and inlet stream 480 comprises stream 474.

Phase two of electrochemical process 400 includes electrodialysis units 456, 458, and 460. The inlet streams (i.e., inlet feed stream 482 and inlet brine stream 488) are sourced from the first phase. For example, inlet feed stream 482 for electrodialysis unit 456 comprises stream 472 (i.e., outlet brine stream of electrodialysis unit 452) and stream 474 (i.e., outlet brine stream of electrodialysis unit 454). Inlet brine stream 488 comprises stream 470 (i.e., outlet brine stream of electrodialysis unit 450). Inlet brine stream 488 of electrodialysis unit 456 also comprises stream 492, which is the outlet brine stream of electrodialysis unit 456.

Stream 484 is the outlet product stream of electrodialysis unit 456 and the inlet feed stream of electrodialysis unit 458. Stream 486 is the outlet product stream of electrodialysis unit 458. In some embodiments, the lithium concentration of stream 486 is within 1-25 g/L of that of stream 466 (i.e., inlet feed stream 466 of electrodialysis unit 454). In some embodiments, the lithium concentrations of stream 486 and stream 466 are within less than 25 g/L, less than 20 g/L, less than 15 g/L, less than 10 g/L, less than 5 g/L, or less than 3 g/L. In some embodiments, the lithium concentrations of stream 486 and stream 466 are within more than 1 g/L, more than 3 g/L, more than 5 g/L, more than 10 g/L, more than 15 g/L, or more than 20 g/L. In some embodiments, stream 466 comprises stream 486.

In some embodiments, the inlet brine streams for the electrodialysis units of the second phase can include the outlet brine streams of the same electrodialysis unit. For example, stream 488 (i.e., inlet brine stream for electrodialysis unit 456) comprises stream 492 (i.e., outlet brine stream of electrodialysis unit 456), stream 490 (i.e., inlet brine stream of electrodialysis unit 458) comprises stream 494 (i.e., outlet brine stream of electrodialysis unit 458), and stream 442 (i.e., inlet brine stream for electrodialysis unit 460) comprises stream 444 (i.e., outlet brine stream for electrodialysis unit 460).

The third electrodialysis unit of the second phase, 460, produces two outlet streams—stream 498 and stream 444. Stream 498 is the outlet product stream of electrodialysis unit 460. In some embodiments, the lithium concentration of stream 498 is within 1-25 g/L of that of stream 464 (i.e., inlet feed stream 464 of electrodialysis unit 452). In some embodiments, the lithium concentrations of stream 498 and stream 464 are within less than 25 g/L, less than 20 g/L, less than 15 g/L, less than 10 g/L, less than 5 g/L, or less than 3 g/L. In some embodiments, the lithium concentrations of stream 498 and stream 464 are within more than 1 g/L, more than 3 g/L, more than 5 g/L, more than 10 g/L, more than 15 g/L, or more than 20 g/L. In some embodiments, stream 464 comprises stream 498.

Stream 444 comprises the product lithium brine that may be used for other processes. In some embodiments, the lithium concentration of stream 444 is 150-250 g/L. In some embodiments, the concentration of lithium in stream 444 is less than 250 g/L, less than 225 g/L, less than 200 g/L, or less than 175 g/L. In some embodiments, the lithium concentration of stream 444 is more than 150 g/L, more than 175 g/L, more than 200 g/L, or more than 225 g/L. In some embodiments, stream 444 comprises 85-99.9% of the lithium originally present in feed stream 462. In some embodiments, stream 444 comprises less than 99.9%, less than 99%, less than 95%, or less than 90% of the lithium originally present in feed stream 462. In some embodiments, stream 444 comprises more than 85%, more than 90%, more than 95%, or more than 99% of the lithium originally present in feed stream 462.

In some embodiments, stream 442 (i.e., inlet brine stream of electrodialysis unit 460) comprises stream 444 (i.e., outlet brine stream of electrodialysis unit 460).

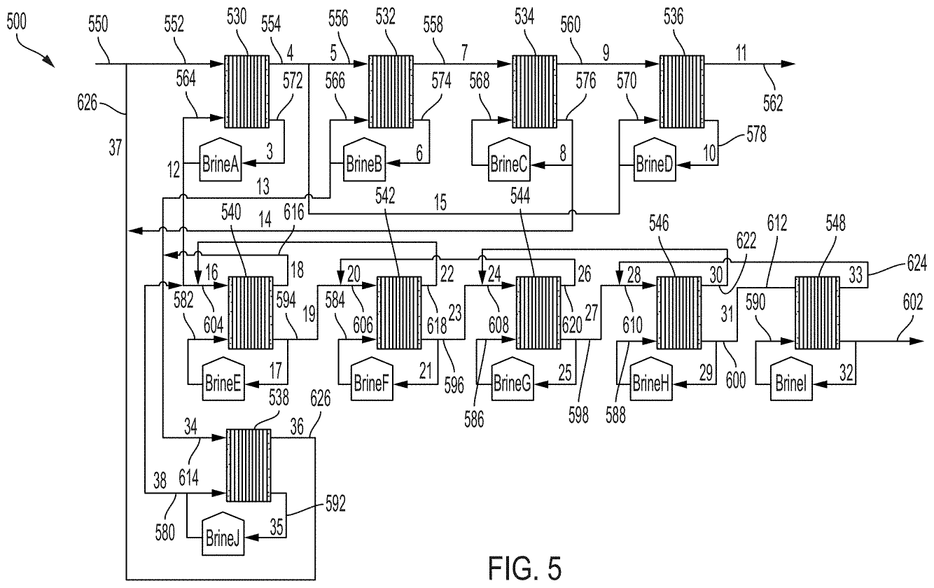

FIG. 5 shows a process diagram for an electrochemical process 500 that separates boron and concentrates lithium, according to some embodiments. As shown, the first phase of electrochemical process 500 includes four electrodialysis units (530, 532, 534, and 536). The second phase of electrochemical process 500 includes six electrodialysis units (538, 540, 542, 544, 546, and 548). However, the first phase and the second phase each may comprise any number of electrodialysis units such as 2, 3, 4, 5, 6, 7, 8, 9, or 10.

In some embodiments, feed stream 550 may comprise lithium, boron, and other dissolved species. In some embodiments, the concentration of lithium in feed stream 550 may be 100-5,000 milligrams per Liter (mg/L). In some embodiments, the concentration of lithium in feed stream 550 may be less than 5,000 mg/L, less than 4,000 mg/L, less than 3,000 mg/L, less than 2,000 mg/L, less than 1,000 mg/L, or less than 500 mg/L. In some embodiments, the concentration of lithium in feed stream 550 may be greater than 100 mg/L, greater than 500 mg/L, greater than 1,000 mg/L, greater than 2,000 mg/L, greater than 3,000 mg/L, or greater than 4,000 mg/L. In some embodiments, the concentration of boron in feed stream 500 may be 50-1,000 mg/L. In some embodiments, the concentration of boron in feed stream 500 may be less than 1,000 mg/L, less than 500 mg/L, or less than 100 mg/L. In some embodiments, the concentration of boron in feed stream 500 may be greater than 50 mg/L, greater than 100 mg/L, or greater than 500 mg/L.

The routing of particular streams of phase one and phase two is dependent upon at least the lithium concentration of that particular stream. In particular, to improve the efficiency of the process, the gradient of each electrodialysis unit should remain relatively low. Table 1, below, provides the gradient within each electrodialysis unit, as well as the lithium recovery percentage and the ion removal percentage.

TABLE 1

| Unit | Recovery | Removal | Gradient |
|---|---|---|---|
| 530 | 86% | 40% | 6 |
| 532 | 80% | 58% | 8 |
| 534 | 88% | 60% | 10 |
| 536 | 87% | 75% | 24 |
| 540 | 66% | 43% | 3 |
| 542 | 35% | 36% | 2 |
| 544 | 33% | 24% | 2 |
| 546 | 45% | 17% | 1 |
| 548 | 29% | 13% | 1 |
| 538 | 46% | 50% | 4 |

In some embodiments, the pH of the feed streams and/or product streams of the first phase may be controlled. For example, the pH of streams 550, 552, 554, 556, 558, and/or 560 may be controlled. In some embodiments, these streams may be controlled to a pH below 9 to minimize the amount of boric acid that dissociates into ions. In some embodiments, these streams may be controlled to a pH of 5-9. In some embodiments, the pH may be less than 9, less than 8, less than 7, or less than 6. In some embodiments, the pH may be more than 5, more than 6, more than 7, or more than 8. In some embodiments, the lower the pH is (and the further away from a pH of 9), the lower the dissociation rate of boric acid. To achieve an outlet product stream of the first phase that comprises at least 85% boron, the pH of the feed and/or product streams should be controlled to a level below 9.

Stream 552 is the inlet feed stream for electrodialysis unit 530. In some embodiments, stream 552 comprises feed stream 550. In some embodiments, stream 552 comprises an outlet product stream from one or more electrodialysis unit of the second phase. For example, stream 552 comprises the outlet product stream of electrodialysis unit 538 of the second phase (i.e., stream 626). Stream 552 comprises stream 628, which comprises the outlet product stream of electrodialysis unit 538 (i.e., stream 626) and the outlet brine stream of electrodialysis unit 534 (i.e., stream 576). The inlet feed stream of electrodialysis unit 532, stream 556, comprises the outlet product stream of electrodialysis unit 530 (i.e., stream 554). In some embodiments, the inlet feed stream for an electrodialysis unit of the first phase may comprise the outlet brine stream of an electrodialysis unit of the first phase. For example, stream 556 (i.e., inlet feed stream of electrodialysis unit 532) comprises stream 578 (i.e., outlet brine stream of electrodialysis unit 536). Stream 558 is the outlet product stream of electrodialysis unit 532 and the inlet feed stream of electrodialysis unit 534. Similarly, stream 560 is the outlet product stream of electrodialysis unit 534 and the inlet feed stream of electrodialysis unit 536. The outlet product stream of electrodialysis unit 536 (i.e., stream 562) comprises 85-99% of the boron initially present in feed stream 550. In some embodiments, stream 562 comprises at least 85%, at least 90%, or at least 95% of the boron initially present in feed stream 550. In some embodiments, stream 562 comprises less than 99%, less than 95%, or less than 90% of the boron initially present in feed stream 550. In some embodiments, stream 562 may comprise 0.1-15% of the lithium originally present in feed stream 550. In some embodiments, stream 562 may comprise less than 15%, less than 10%, less than 5%, or less than 1% of the lithium originally present in feed stream 550. In some embodiments, stream 562 may comprise more than 0.1%, more than 1%, more than 5%, or more than 10% of the lithium originally present in feed stream 550. In some embodiments, a boron removal unit may be used to store and/or process stream 562.

In some embodiments, the inlet brine stream of an electrodialysis unit of the second phase may comprise the outlet brine stream of the same electrodialysis unit. For example, the inlet brine stream of electrodialysis unit 538, stream 580, comprises the outlet brine stream of electrodialysis unit 538, stream 592. The inlet brine stream of electrodialysis unit 540, stream 582, comprises the outlet brine stream of electrodialysis unit 540, stream 594. The inlet brine stream of electrodialysis unit 542, stream 584, comprises the outlet brine steam of electrodialysis unit 542, stream 596. The inlet brine stream of electrodialysis unit 544, stream 586, comprises the outlet brine stream of electrodialysis unit 544, stream 598. The inlet brine stream of electrodialysis unit 546, stream 588, comprises the outlet brine stream of electrodialysis unit 546, stream 600. Finally, the inlet brine stream for electrodialysis unit 548, stream 590, comprises the outlet brine stream for electrodialysis unit 548, stream 602.

In some embodiments, one or more inlet streams of the second phase comprise one or more outlet streams of the first phase. For example, inlet feed stream of electrodialysis unit 538, stream 614, comprises the outlet brine stream of electrodialysis unit 532 of the first phase (i.e., stream 574). The inlet brine stream of electrodialysis unit 538, stream 580, comprises the outlet brine stream of electrodialysis unit 530 (i.e., stream 572). The inlet feed stream of electrodialysis unit 540, stream 604, comprises the outlet brine stream of electrodialysis unit 530 of the first phase (i.e., stream 572). The inlet feed stream of electrodialysis unit 540, stream 604, also includes the outlet product stream of electrodialysis unit 542 (i.e., stream 618).

In some embodiments, the outlet brine stream of the last electrodialysis unit of the second phase (i.e., stream 602 of electrodialysis unit 548) comprises the product brine stream that may be used for other processes. In some embodiments, the lithium concentration of stream 602 is 150-250 g/L. In some embodiments, the concentration of lithium in stream 602 is less than 250 g/L, less than 225 g/L, less than 200 g/L, or less than 175 g/L. In some embodiments, the lithium concentration of stream 602 is more than 150 g/L, more than 175 g/L, more than 200 g/L, or more than 225 g/L. In particular, lithium concentrations of 150 g/L or greater may preempt the need to use thermal evaporation processes. In some embodiments, stream 602 comprises 85-99.9% of the lithium originally present in feed stream 550. In some embodiments, stream 602 comprises less than 99.9%, less than 99%, less than 95%, or less than 90% of the lithium originally present in feed stream 550. In some embodiments, stream 602 comprises more than 85%, more than 90%, more than 95%, or more than 99% of the lithium originally present in feed stream 550. In some embodiments, stream 602 may be routed to a crystallizer.

In some embodiments, the inlet feed streams of an electrodialysis unit of the second phase may comprise a brine outlet stream of another electrodialysis unit. For example, the inlet feed stream of electrodialysis unit 540, stream 604, comprises the outlet brine stream of electrodialysis unit 538, stream 592. The inlet feed stream of electrodialysis unit 542, stream 606, comprises the outlet brine stream of electrodialysis unit 540, stream 594. The inlet feed stream of electrodialysis unit 544, stream 608, comprises the outlet brine stream of electrodialysis unit 542, stream 596. The inlet feed stream electrodialysis unit 546, stream 610, comprises the outlet brine stream of electrodialysis unit 544, stream 598. The inlet feed stream of electrodialysis unit 548, stream 612, comprises the outlet brine stream of electrodialysis unit 546, stream 600.

In some embodiments, the inlet feed stream of an electrodialysis unit of the second phase may comprise the outlet product stream of another electrodialysis unit of the second phase. For example, the inlet feed stream of electrodialysis unit 540, stream 604, comprises outlet product stream of electrodialysis unit 542, stream 618. The inlet feed stream of electrodialysis unit 542, stream 606, comprise the outlet product stream of electrodialysis unit 544, stream 620. The inlet feed stream of electrodialysis unit 546, stream 610, comprises the outlet product stream of electrodialysis unit 548, stream 624.

Table 2, below, shows the flow rates and lithium concentrations (parts per thousand or grams per Liter) per stream.

TABLE 2

| | Flow Rate | Concentration |
|---|---|---|
| Stream | gpm | g/L |
| 550 | 800 | 20 |
| 552 | 1245 | 20 |
| 572 | 172 | 70 |
| 554 | 1073 | 12 |
| 556 | 1182 | 12 |
| 574 | 128 | 40 |
| 558 | 946 | 5 |
| 576 | 111 | 20 |
| 560 | 834 | 2 |
| 578 | 109 | 12 |
| 562 | 726 | 0.5 |
| 566 | 128 | 40 |
| 604 | 894 | 70 |
| 594 | 300 | 110 |
| 616 | 594 | 40 |
| 606 | 397 | 110 |
| 596 | 212 | 145 |
| 618 | 140 | 70 |
| 608 | 299 | 145 |
| 598 | 161 | 175 |
| 620 | 97 | 110 |
| 610 | 191 | 175 |
| 600 | 104 | 200 |
| 622 | 87 | 145 |
| 602 | 74 | 210 |
| 624 | 30 | 175 |
| 614 | 722 | 40 |
| 592 | 388 | 70 |
| 626 | 334 | 20 |
| 628 | 445 | 20 |
| 580 | 388 | 70 |

The preceding description sets forth exemplary methods, parameters and the like. It should be recognized, however, that such description is not intended as a limitation on the scope of the present disclosure but is instead provided as a description of exemplary embodiments. The illustrative embodiments described above are not meant to be exhaustive or to limit the disclosure to the precise forms disclosed. Many modifications and variations are possible in view of the above teachings. The embodiments were chosen and described to best explain the principles of the disclosed techniques and their practical applications. Others skilled in the art are thereby enabled to best utilize the techniques, and various embodiments with various modifications as are suited to the particular use contemplated.

Although the disclosure and examples have been thoroughly described with reference to the accompanying figures, it is to be noted that various changes and modifications will become apparent to those skilled in the art. Such changes and modifications are to be understood as being included within the scope of the disclosure and examples as defined by the claims. In the preceding description of the disclosure and embodiments, reference is made to the accompanying drawings, in which are shown, by way of illustration, specific embodiments that can be practiced. It is to be understood that other embodiments and examples can be practiced, and changes can be made without departing from the scope of the present disclosure.

Although the preceding description uses terms first, second, etc. to describe various elements, these elements should not be limited by the terms. These terms are only used to distinguish one element from another.

Also, it is also to be understood that the singular forms “a,” “an,” and “the” used in the preceding description are intended to include the plural forms as well unless the context indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

The term “if” may be construed to mean “when” or “upon” or “in response to determining” or “in response to detecting,” depending on the context.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

1. A water treatment system comprising:
a first phase comprising a first plurality of electrodialysis units configured to separate boron from a feed stream, wherein each electrodialysis unit of the first plurality of electrodialysis units comprises an inlet feed stream, an inlet brine stream, an outlet product stream, and an outlet brine stream; and
a second phase comprising a second plurality of electrodialysis units, wherein each electrodialysis unit of the second plurality of electrodialysis units comprises an inlet feed stream, an inlet brine stream, an outlet product stream, and an outlet brine stream,
wherein the feed stream of at least one electrodialysis unit of the second plurality of electrodialysis units comprises an outlet brine stream of at least one electrodialysis unit of the first plurality of electrodialysis units, and
wherein the second plurality of electrodialysis units are configured to produce a product brine stream achieving 90-99% lithium recovery.

2. The water treatment system of claim 1, wherein the first phase comprises a first electrodialysis unit, a second electrodialysis unit, and a third electrodialysis unit.

3. The water treatment system of claim 2, wherein the inlet feed stream of the first electrodialysis unit of the first phase comprises the feed stream.

4. The water treatment system of claim 2, wherein the inlet feed stream of the second electrodialysis unit of the first phase comprises the outlet product stream of the first electrodialysis system of the first phase.

5. The water treatment system of claim 2, wherein the inlet feed stream of the third electrodialysis system of the first phase comprises the outlet product stream of the second electrodialysis unit of the first phase.

6. The water treatment system of claim 2, wherein the outlet product stream of the third electrodialysis unit of the first phase recovers greater than 95% of the boron ions of the feed stream.

7. The water treatment system of claim 2, wherein at least one of the inlet feed stream of the first electrodialysis unit of the first phase, the inlet feed stream of the second electrodialysis unit of the first phase, or the inlet feed stream of the third electrodialysis unit of the first phase are controlled to a pH of 7 or lower.

8. The water treatment system of claim 2, wherein the second phase comprises a first electrodialysis unit, a second electrodialysis unit, and a third electrodialysis unit.

9. The water treatment system of claim 8, wherein the inlet feed stream of the first electrodialysis system of the second phase comprises at least one of the outlet brine stream of the second electrodialysis unit of the first phase or the outlet brine stream of the third electrodialysis system of the first phase.

10. The water treatment system of claim 8, wherein the inlet brine stream of the first electrodialysis unit of the second phase comprises the outlet brine stream of the first electrodialysis unit of the first phase.

11. The water treatment system of claim 8, wherein the inlet brine stream of the first electrodialysis unit of the second phase comprises the outlet brine stream of the first electrodialysis unit of the second phase.

12. The water treatment system of claim 8, wherein the inlet feed stream of the second electrodialysis unit of the second phase comprises the outlet product stream of the first electrodialysis unit of the second phase.

13. The water treatment system of claim 8, wherein the inlet feed stream of the third electrodialysis unit of the second phase comprises the outlet brine stream of the second electrodialysis unit of the second phase.

14. The water treatment system of claim 8, wherein the inlet brine stream of the third electrodialysis unit of the second phase comprises the outlet brine stream of the first electrodialysis unit of the second phase.

15. The water treatment system of claim 8, wherein the inlet feed stream of the first electrodialysis system of the second phase comprises at least one of the outlet brine stream of the first electrodialysis system of the first phase, the outlet brine stream of the second electrodialysis system of the first phase, or the outlet brine stream of the third electrodialysis system of the first phase.

16. The water treatment system of claim 8, wherein the inlet brine stream of the first electrodialysis system of the second phase comprises at least one of the outlet brine stream of the first electrodialysis system of the first phase, the outlet brine stream of the second electrodialysis system of the first phase, or the outlet brine stream of the third electrodialysis system of the first phase.

17. The water treatment system of claim 8, wherein the inlet brine stream of the first electrodialysis unit of the second phase comprises the outlet brine stream of the first electrodialysis system of the second phase.

18. The water treatment system of claim 8, wherein the inlet feed stream of the third electrodialysis unit of the first phase comprises the outlet product stream of the second electrodialysis unit of the second phase.

19. A method of separating boron and concentrating lithium comprising:
passing water through a first phase comprising a first plurality of electrodialysis units configured to separate boron from a feed stream, wherein each electrodialysis unit of the first plurality of electrodialysis units comprises an inlet feed stream, an inlet brine stream, an outlet product stream, and an outlet brine stream; and
passing water through a second phase comprising a second plurality of electrodialysis units, wherein each electrodialysis unit of the second plurality of electrodialysis units comprises an inlet feed stream, an inlet brine stream, an outlet product stream, and an outlet brine stream,
wherein the feed stream of at least one electrodialysis unit of the second plurality of electrodialysis units comprises an outlet brine stream of at least one electrodialysis unit of the first plurality of electrodialysis units, and
wherein the second plurality of electrodialysis units are configured to produce a product brine stream achieving 90-99% lithium recovery.

20. The method of claim 19, wherein the outlet product stream of the third electrodialysis unit of the first phase recovers greater than 95% of the boron ions of the feed stream.
